(19) United States
(12) Patent Application Publication
(10) Pub. No.: US 2015/0188333 A1
(43) Pub. Date: Jul. 2, 2015

(54) BATTERY PACK, CHARGING ASSEMBLY AND ELECTRIC TOOL

(71) Applicant: CHERVON INTELLECTUAL PROPERTY LIMITED, Road Town (VG)

(72) Inventors: Yuexiang Zhang, Nanjing (CN); Xiaohong Lin, Nanjing (CN)

(73) Assignee: CHERVON INTELLECTUAL PROPERTY LIMITED

(21) Appl. No.: 14/583,352

(22) Filed: Dec. 26, 2014

(30) Foreign Application Priority Data
Dec. 31, 2013 (CN) 201310752428.7
Sep. 30, 2014 (CN) 201410521055.7
Sep. 30, 2014 (CN) 201410523039.1

(51) Int. Cl. H02J 7/00; H01M 2/30; B25F 5/00; H01M 2/10

(52) U.S. Cl. CPC H02J 7/0013; H01M 2/1055; H01M 2/30; B25F 5/00; H02J 7/0042; H01M 2220/30

(57) ABSTRACT

A battery pack is constructed to output high voltage. The battery pack includes a battery housing, a battery cell assembly, and more than two connection terminals. The battery housing has an insert housing wall. The insert housing wall has an insertion structure having an insertion direction which forms an angle greater than or equal to 0 degree and less than or equal to 45 degrees with respect to a maximum projection surface or a maximum size direction of the battery cell assembly. A charging assembly and an electric tool are provided for use with the battery pack.

### RELATED APPLICATION INFORMATION

This application claims the benefit of CN201310752428.7, filed on Dec. 31, 2013, CN201410521055.7, filed on Sep. 30, 2014, and CN201410523039.1, filed on Sep. 30, 2014, the disclosures of which are incorporated herein by reference in their entirety.

### FIELD OF THE DISCLOSURE

The present disclosure relates to a battery pack, a charging assembly and an electric tool.

### BACKGROUND

A battery pack, as a power source of a cordless electrical tool, is generally the component that functions to limit development of cordless electrical tools. Conventional battery packs usually only have an output voltage under 30V, and upon driving large-power electric tools, they usually cause problems such as insufficient power and undesirable endurance. Currently there is not a battery pack whose output voltage is above 30V and whose structure is safe and reasonable, and a charger adapted for the battery pack.

The statements in this section merely provide background information related to the present disclosure and may not constitute prior art.

### SUMMARY

To overcome the drawbacks in the prior art, an object of the present disclosure is to provide a charging assembly for a battery pack whose output voltage exceeds 30V and whose structure is safe and reasonable.

To achieve the above object, the present disclosure generally describes a battery pack, comprising: a battery housing, a battery cell assembly, and more than two connection terminals capable of transmitting electrical energy or signals, the battery housing comprising an insert housing wall; the battery cell assembly comprising more than one battery cell unit; wherein the battery pack at least has an output voltage of 56V; and the insert housing wall comprises an insertion structure and terminal ports, the insertion structure at least having an insertion direction which forms an angle greater than or equal to 0 degree and less than or equal to 45 degrees with respect to a maximum projection surface or a maximum size direction of the battery cell assembly.

Furthermore, the insertion structure may at least comprise an insertion starting end and an insertion terminating end in the insertion direction, and the terminal ports may be located on a side of the insertion structure adjacent to the insertion terminating end.

Furthermore, the maximum projection surface of the insert housing wall may overlap the maximum projection surface of the battery cell assembly.

Furthermore, the insertion direction may be parallel to the maximum projection surface of the battery cell assembly.

Furthermore, the insertion direction may be parallel to the maximum size direction of the battery cell assembly.

Furthermore, the insertion structure may comprise insertion slots and a receiving slot; a direction perpendicular to a maximum projection surface of the insert housing wall may be regarded as an up-down direction, and a direction parallel to the insertion direction may be regarded as a front-rear direction, a side where the insertion starting end is located may be regarded as a front side, and a side where the insertion terminating end is located may be regarded as a rear side; two insertion slots may be respectively disposed on left and right sides above the receiving slot, the insertion slots and the receiving slot may be opened on the front side, the two insertion slots may be respectively opened leftwards and rightwards, and the receiving slot may be recessed downwards and opened upwards.

Furthermore, a left-right distance of a bottom surface of the insertion slot may be in a range of 90 mm to 95 mm.

Furthermore, the battery housing may be provided with a heat dissipation structure, the heat dissipation structure at least comprises a main heat dissipation window disposed at the insert housing wall.

Furthermore, the insert housing wall may be provided with a main heat dissipation panel parallel to the maximum projection surface of the insert housing wall, and the main heat dissipation window may be disposed at the main heat dissipation panel; a ratio of a heat dissipation area of the main heat dissipation window to a total heat dissipation area of the heat dissipation structure may be in a range of 0.4 to 0.6; a ratio of the total heat dissipation area of the heat dissipation structure to a volume of the battery housing may be in a range of 0.0005 mm²/mm³ to 0.0012 mm²/mm³; a ratio of the total heat dissipation area of the heat dissipation structure to a surface area of the battery housing may be in a range of 0.015 to 0.030.

Furthermore, the insertion slot may at least comprise two different segments in the front-rear direction, and a cross section of a forward segment may be greater than that of a rearward segment.

Furthermore, a length of the insertion slot in the insertion direction may be in a range of 90 mm to 100 mm.

Furthermore, the insert housing wall may form a stop wall surface behind the receiving slot, and the terminal port may be partially provided on the stop wall surface and located between the two insertion slots.

Furthermore, the insert housing wall may be formed with a wall surface structure having an L-shaped section, wherein the wall surface structure comprises a locking wall surface corresponding to one edge of the L-shape and a stopping wall surface corresponding to the other edge of the L-shape; the locking wall surface may be parallel to the maximum projection surface of the insert housing wall, and the stopping wall surface may be perpendicular to the maximum projection surface of the insert housing wall, and one terminal port may be formed by hollowing the locking wall surface and the stopping wall surface as well as a connection portion there between.

Furthermore, four terminal ports may be arranged left-right symmetrically, each terminal port may have a left-right symmetrical structure, and a distance of the two terminal ports in the middle may be smaller than or equal to a distance between one of the two terminal ports in the middle and the respective outside terminal port; a battery pack positive connection terminal and a battery pack negative connection terminal may be correspondingly provided at the two outside terminal ports; and a communication connection terminal and a temperature connection terminal may be correspondingly provided at the two inside terminal ports.

Furthermore, a dimension of the terminal port in the left-right direction may be in a range of 1.5 mm to 2 mm, its dimension in the up-down direction may be in a range of 15 mm to 20 mm, and its dimension in the front-rear direction may be in a range of 10 mm to 20 mm; a centerline of the left-right symmetry terminal port may be called a central line, and a distance between the central lines of adjacent terminal ports may be in a range of 3 mm to 12 mm.

Furthermore, two wrong insertion-preventing slots having different sizes may be provided at a connection of the locking wall surface and the stopping wall surface and arranged inside the two insertion slots.

Furthermore, the battery pack may further comprise a main control circuit board disposed in the battery housing, wherein a maximum projection surface of the main control circuit board may be perpendicular to the insertion direction.

Furthermore, a direction parallel to the insertion direction may be regarded as a front-rear direction, a side where the insertion starting end is located may be regarded as a front side, and a side where the insertion terminating end is located may be regarded as a rear side; the main control circuit board may be located behind the battery cell assembly and spaced apart from it at least 15 mm.

Furthermore, the battery housing may further comprise an end cap whose maximum projection surface is perpendicular to the maximum projection surface of the battery cell assembly, and the end cap may be formed with a receiving space for receiving the main control circuit board.

Furthermore, a distance of the connection terminal from an outer surface of the insert housing wall may be greater than or equal to 7 mm.

Furthermore, in the insertion direction of the insertion structure, a center of gravity of the battery pack may be located between the insertion starting end and the insertion terminating end.

Furthermore, an electrical energy capacity of the battery pack may be greater than 100 Wh.

Furthermore, a ratio of the electrical energy capacity of the battery pack to its weight may be greater than 70 Wh/kg and less than 100 Wh/kg; a ratio of the electrical energy capacity of the battery pack to its volume may be greater than 70 Wh/cm³ and less than 100 Wh/cm³.

Also generally described is a charger comprising a charging housing, a charging device, and a charging terminal to electrically connect the charging device to the battery pack; the charging housing comprising a charging housing wall including a mounting structure for mounting the battery pack to a mounting position, wherein the mounting structure at least has a mounting direction which forms an angle greater than or equal to 0 degree and less than or equal to 45 degrees with respect to a maximum projection surface of the charging housing wall.

Furthermore, the mounting direction may be parallel to the maximum projection surface of the charging housing wall; the mounting structure may comprise insertion protrusions and a positioning protrusion, and the mounting structure may at least comprise a mounting starting end and a mounting terminating end in the mounting direction; a direction perpendicular to the maximum projection surface of the charging housing wall may be an up-down direction; the charging housing wall may be located on an upper side in the charging housing; a direction parallel to the mounting direction may be the front-rear direction, a side where the mounting starting end is located may be regarded as a front side, and a side where the mounting terminating end is located may be regarded as a rear side; the positioning protrusion may protruded upwardly, and two insertion protrusion may be respectively disposed on left and right bottom sides of the positioning protrusion and respectively protruded leftwards and rightwards.

Furthermore, at a front end of the insertion protrusion and the positioning protrusion, the charging housing wall may be formed with a positioning wall surface for stopping the battery pack to limit it in the mounting position; the charging terminal may be located on a side of the mounting structure adjacent to the mounting starting end.

Furthermore, the charger may further comprise a safety switch disposed in the charging housing and configured to control whether the charging terminal is charged or not.

Furthermore, an insurance switch may be provided at the mounting terminating end and triggered by contact of the battery pack at the mounting position and reset when the battery pack retreats out of the mounting position; the insurance switch may form a linkage with the safety switch; when the insurance switch is triggered, the safety switch may cause the charging terminal to be placed into a state for charging; when the insurance switch is reset, the safety switch may cause the charging terminal to be placed into a state for uncharging.

Furthermore, the charging housing may be formed with an air duct structure, the air duct structure may at least comprise an air inlet and an air outlet; the air inlet may be disposed at the charging housing wall, and the charger may be provided with an air flow element in a channel between the air inlet and the air outlet.

Furthermore, the charging terminal may be disposed at the positioning wall surface and located between the two insertion protrusions; the maximum projection surface of the charging housing wall may be perpendicular to a horizontal plane.

Furthermore, the charger may at least have a charging voltage of 56V and a charging power of 550 W.

Furthermore, the charging terminal may be configured as a sheet-shaped terminal with a thickness in a range of 0.5 mm to 1 mm and a distance extending out of a housing of a charger in the front direction and the up-down direction may be a range of 15 mm to 20 mm.

Furthermore, the charging terminal may extend out of the charging housing at least 7 mm.

Still further is described an electric tool adapted to the aforesaid battery pack which comprises the aforesaid battery pack and a main machine powered by the battery pack, the main machine comprises a motor, a tool housing, and a tool terminal for forming electrical energy or signal transmission with the battery pack, wherein the motor is disposed in the tool housing; the tool housing comprises a loading housing wall; and the loading housing wall comprises a loading structure for loading the battery pack to a loading position.

Furthermore, the loading structure may at least have a loading direction parallel to the insertion direction.

Furthermore, the loading structure may comprise loading protrusions and a central protrusion, a direction perpendicular to a maximum projection surface of the tool housing wall may be regarded as an up-down direction, and a direction parallel to a loading direction may be regarded as a front-rear direction; the central protrusion may be protruded upward, and two loading protrusions may be respectively provided on left and right bottom sides of the central protrusion and respectively protruded leftwards and rightwards.

Furthermore, the main machine may comprise a locking mechanism for locking the battery pack at a loading position, and the insert housing wall may be formed with a locking structure cooperating with the locking mechanism; the main machine may further comprise an ejection structure for ejecting the battery pack out of the loading position, and the battery pack may be provided with an ejection wall surface contacting with the ejection mechanism; a maximum projection surface of the ejection wall surface may be perpendicular to the loading direction.

Furthermore, a distance of the tool terminal away from an outer surface of the loading housing wall may be greater than or equal to 7 mm, the tool terminal may be configured as a sheet-shaped terminal with a thickness in a range of 0.5 mm to 1 mm and a distance extending out of the tool housing may be a range of 15 mm to 20 mm.

Furthermore, the electric tool may be a mower, and a weight ratio of the battery pack to the main machine may be in a range of 0.04 to 0.14.

Furthermore, the electric tool may be a pruner, and a weight ratio of the battery pack to the main machine may be in a range of 0.4 to 0.6.

Furthermore, the electric tool may be a chain saw, and a weight ratio of the battery pack to the main machine may be in a range of 0.250 to 0.875.

Furthermore, the electric tool may be an air blower, and a weight ratio of the battery pack to the main machine may be in a range of 0.04 to 1.

Furthermore, the electric tool may be a grass trimmer, and a weight ratio of the battery pack to the main machine may be in a range of 0.3 to 0.8.

### BRIEF DESCRIPTION OF THE DRAWINGS

FIG. 1 is a structural schematic view of an exemplary battery pack constructed according to the present disclosure;

FIG. 2 is a structural schematic view of the battery pack of FIG. 1 as viewed from another angle;

FIG. 3 is a structural schematic view of a whole structure of a plurality of battery cells in the battery pack as shown in FIG. 1;

FIG. 4 is a structural schematic view of the battery pack of FIG. 1 as viewed in a direction perpendicular to a maximum projection surface of an insert housing wall;

FIG. 5 is a structural schematic view of the battery pack of FIG. 1 as viewed in a direction parallel with the maximum projection surface of the insert housing wall;

FIG. 6 is a cross sectional view taken along line D-D of FIG. 5;

FIG. 7 is a structural schematic view of partial internal structures of the battery pack of FIG. 1;

FIG. 8 is a structural schematic view of an exemplary charging assembly constructed according to the present disclosure;

FIG. 9 is a structural schematic view of the charger shown in FIG. 8;

FIG. 10 is a schematic view of a heat dissipation structure and an air duct structure in the charging assembly shown in FIG. 9;

FIG. 11 is a structural schematic view of an exemplary charger also constructed according to the present disclosure;

FIG. 12 is a schematic view of internal structures of the charger shown in FIG. 11;

FIG. 13 is a schematic view of internal structures of the charger shown in FIG. 11 as viewed from another angle;

FIG. 14 is a schematic view of an exemplary electric tool constructed according to the present disclosure;

FIG. 15 is a schematic view of the electric tool shown in FIG. 14 when the battery pack is in a detached state; and

FIG. 16 is a partial schematic view of a main machine of the electric tool shown in FIG. 14.

The drawings described herein are for illustrative purposes only of exemplary embodiments and not all possible implementations, and are not intended to limit the scope of the present disclosure. Corresponding reference numerals indicate corresponding parts throughout the several views of the drawings.

### DETAILED DESCRIPTION

The following description of preferred embodiments is merely exemplary in nature and is in no way intended to limit the invention as set forth in the claims provided herewith, its application, or uses.

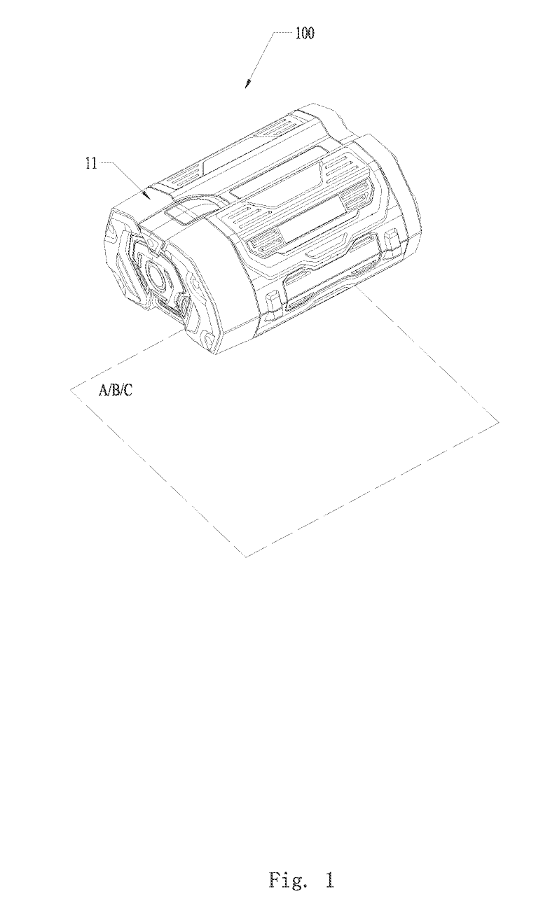

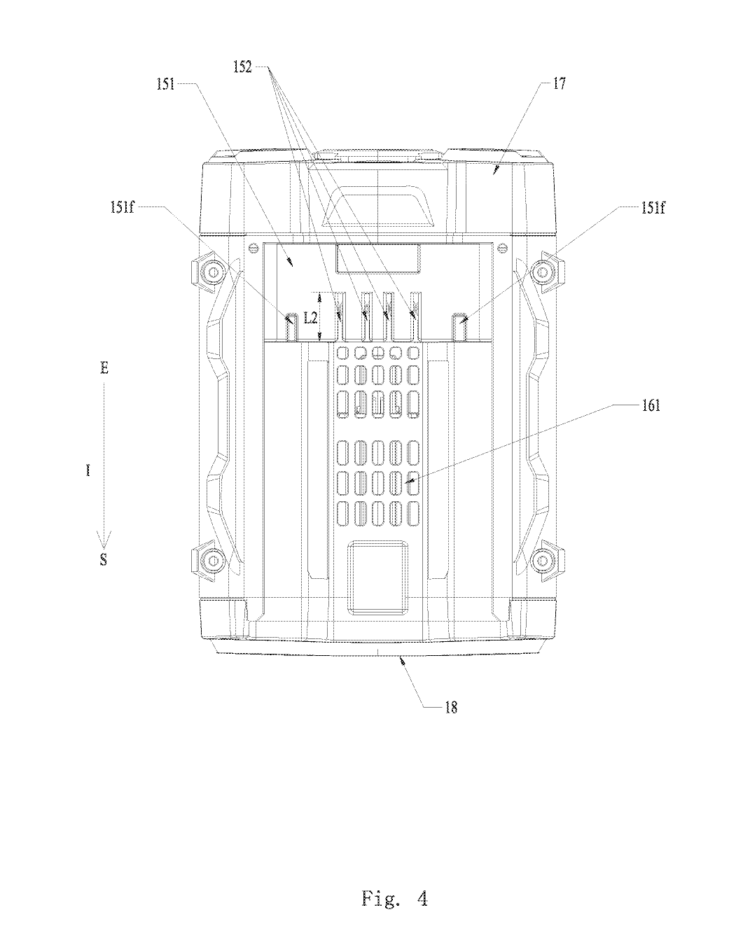

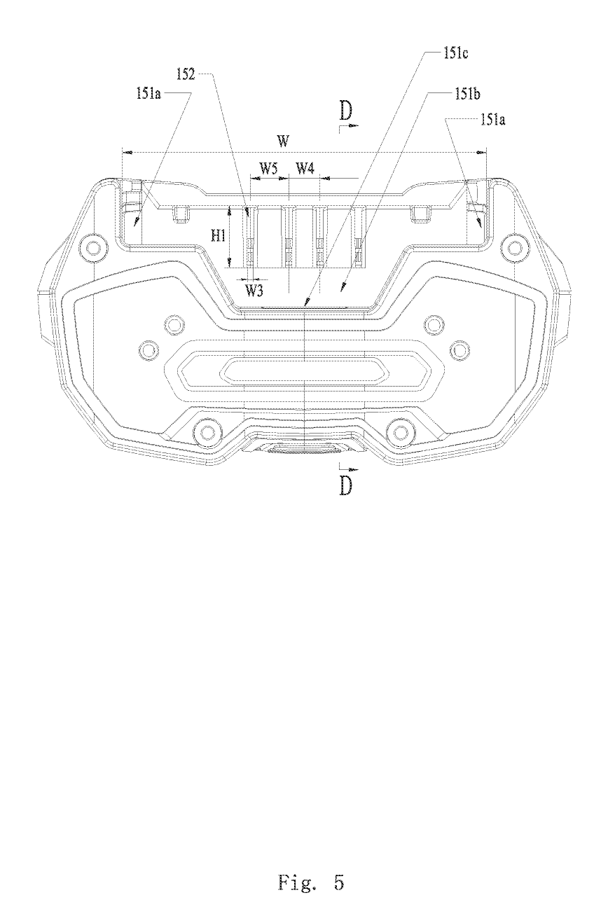

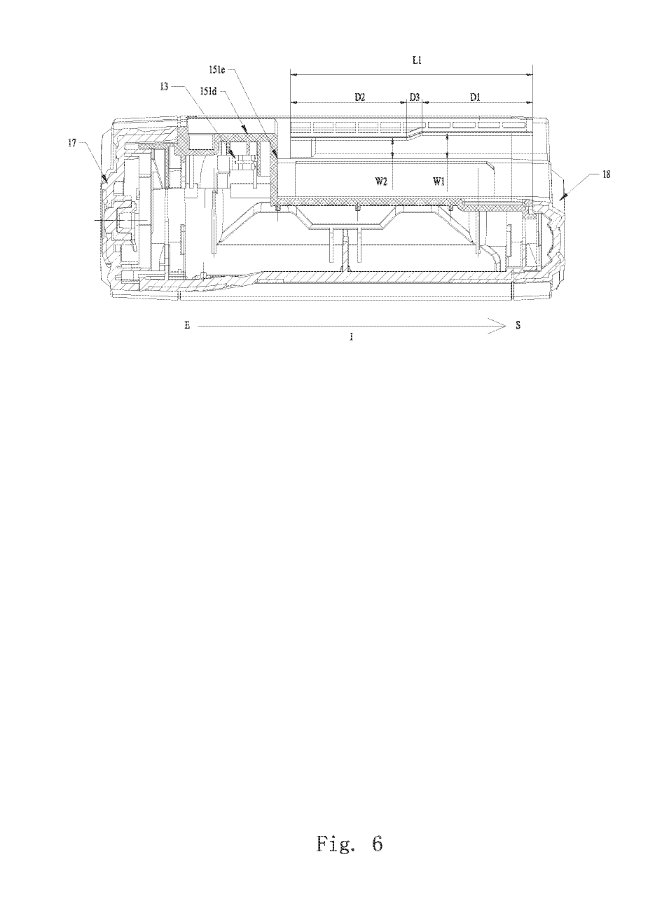

Referring to FIG. 1 to FIG. 7, a battery pack 100 constructed according to the present disclosure comprises a battery housing 11, a battery cell assembly 12, a plurality of connection terminals 13, a main control circuit board 14; wherein the battery pack 100 at least has an output voltage of 56V. As far as a capability of the output voltage is concerned, the battery pack can output an output voltage of at least 56V.

The battery cell assembly 12 comprises more than one battery cell unit 121, and the battery cell assembly 12 is configured as a whole comprising a plurality of battery cell units 121 which are in a certain electrical connection relationship and arranged according to a certain structure, and it is disposed in the battery housing 11 as an electrical power source of the battery pack 100. Certainly, it is not excluded that the battery cell assembly 12 only includes one battery cell unit 121.

The battery pack 100 should form a relatively compact structure in a 3D space so that it can be easily carried and can be easily inserted into a corresponding charger 200 and an electric tool 300. As far as the battery pack 100 having a smaller output voltage is concerned, the number of the battery cell units 121 is limited, so the layout of the battery cell units 121 usually need not be considered, and the only thing to do is to arrange them tidy.

However, as far as the battery pack 100 of the present disclosure is concerned, it at least has an output voltage of 56V, so it must have relatively more battery cell units 121 and each battery cell unit 121 has larger heat generation upon being supplied power and charge. If the battery cell units are arranged tidy according to current arrangement method, heat inside the battery pack 100 concentrates and is hard to be dissipated so as to cause a hidden danger. The relatively more battery cell units 121 cannot be simply disposed linearly in a certain dimension, and the shape and size of the resultant battery pack is not suitable for carrying and installation.

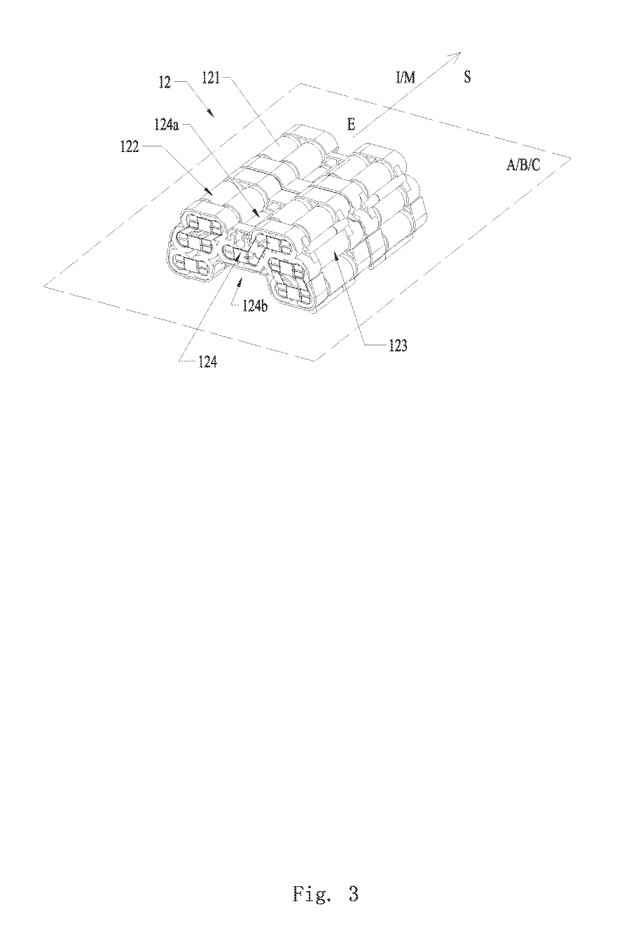

Therefore, as a preferred solution, referring to FIG. 3, the battery cell unit 121 is generally cylindrical. In order to expose as much as possible the surface of the battery cell units 121 in the battery cell assembly 12, the battery cell units 121 may be arranged in a manner as shown in FIG. 3. Assume that a maximum projection surface A of the parallel battery cell assembly 12 is oriented in a horizontal direction, vertically adjacent battery cell units 121 are disposed staggered in the horizontal direction, and horizontally adjacent battery cell units 121 may be disposed either staggered or aligned. To make the battery cell units 121 have sufficient heat dissipation area and meanwhile make a size of the whole battery cell assembly 12 not too large, the horizontally adjacent battery cell units 121 are arranged aligned. That is to say, in a 3D coordinate system, a plurality of battery cell units 121 may be arranged repeatedly in two of the dimensions, and adjacent battery cell units 121 are arranged staggered in the remaining one dimension. Certainly, it is feasible to arrange adjacent battery cell units 121 staggered in two dimensions even three dimensions. However, this obviously increases the size of the battery pack 100 so that its structure is not compact. Therefore, the solution as shown in FIG. 3 caters to both heat dissipation and the size of the battery pack.

Referring to the solution as shown in FIG. 3, it is improved not only in respect of the arrangement manner of the battery cell units 121 but also in respect of the shape of the whole battery cell assembly 12 composed of the battery cell units 121. As known from FIG. 3, when the battery cell units 121 are arranged in a staggered manner in a certain dimension, it is difficult for the whole battery cell assembly 12 to form a regular 3D shape. As a preferred solution, the battery cell assembly 12 comprises a left unit body 122 and a right unit body 123 which are mirror-symmetrical, and a connecting unit body 124 provided there between, wherein the left unit body 122 and the right unit body 123 form mirror symmetry, and the symmetrical mirror surface is perpendicular to the maximum projection surface A of the battery cell assembly 12. If the maximum projection surface A of the parallel battery cell assembly 12 is regarded as being in the horizontal direction, the left unit body 122 and right unit body 123 go beyond the connecting unit body 124 on both upper and lower sides and form two grooves 124a and 124b having different sizes on both sides of the connecting unit body 124.

Specifically, both the left unit body 122 and the right unit body 123 comprise three layers of the battery cell units 121, and each layer comprises many vertically-aligned battery cell units 121, namely, the battery cell units 121 are arranged repeatedly in the horizontal direction. Each layer is disposed staggered relative to the upper layer towards the side away from the connecting unit body 124, and the connecting unit body 124 only comprises one layer of the battery cell units 121 and is aligned with an intermediate layer of the left unit body 122 and the right unit body 123. Both sides of the layer of the connecting unit body 124 and one more layer on both sides of the left unit body 122 and right unit body 123 form two grooves 124a, 124b having different sizes (because different layers are arranged in staggered form outwardly). Such arrangement is advantageous in that the lateral sides of all cylindrical battery cell units 121 in the left unit body 122 are partially exposed, but not completely encompassed by the surrounding battery cell units 121, so that all battery cell units 121 can effectively dissipate heat and thereby avoid heat concentration. It is the same with the right unit body 123. Regarding the connecting unit body 124, all battery cell units 121 included therein do not have structure blocking heat dissipation on both upper and lower sides, so they can more easily dissipate heat.

It should be noted that, since the connecting unit body 124 can more easily dissipate heat as compared with the left unit body 122 and the right unit body 123, if all battery cell units 121 dissipate equivalent heat, heat will diffuse from the left unit body 122 and the right unit body 123 towards to the two grooves 124a, 124b having different sizes on both sides of the connecting unit body 124, especially the larger groove 124b.

This is also an advantage of the battery cell assembly 12 of the present disclosure arranged as shown in FIG. 3. When the battery housing 11 is provided, a major ventilating structure for heat dissipation purpose is correspondingly disposed at the groove 124b, whereby a larger heat dissipation area can be obtained and high heat dissipation efficiency can be achieved since the battery cell units 121 exist on three sides of this location. More advantageously, the battery cell assembly 12 itself has heat diffusion from the left unit body 122 and right unit body 123 towards the groove 124b; if a ventilating structure is disposed at this location to further guide the heat diffusion, heat is diffused out of the battery housing 11 more effectively. Correspondingly, the area of ventilating structures provided at the remaining locations of the battery housing 11 may be reduced to ensure structural strength of the whole battery housing 11.

As a preferred solution, the battery housing 11 has a shape suitable for the battery cell assembly 12.

Referring to FIGS. 1, 2, 4, and 7, the battery housing 11 comprises an insert housing wall 15 mainly used to achieve insertion and electrical connection of the battery pack 100 with the charger 200 and the electrical tool 300. Certainly, the battery housing 11 further comprises other housing wall portions.

The insert housing wall 15 comprises an insertion structure 151 and terminal ports 152. The insertion structure 151 at least has an insertion direction I, the insertion direction I forms an angle greater than 0 degree and less than 45 degrees with respect to the maximum projection surface A or a maximum size direction M of the battery cell assembly 12, or forms an angle greater than 0 degree and less than 45 degrees with respect to both the maximum projection surface A and the maximum size direction M of the battery cell assembly 12.

Such design is advantageous in the following: the battery pack of the present disclosure at least has an output voltage of 56V, so it has more battery cell units 121 than general battery packs having a lower output voltage and its size and weight are larger. Therefore, to ensure a sufficient contact area to achieve stop effect perpendicular to the insertion direction I and a sufficient insertion length upon insertion, firstly, it tries to be parallel with the maximum size direction M of the battery cell assembly 12 to obtain a sufficient insertion length, and secondly, it seeks to be parallel with the maximum projection surface A of the battery cell assembly 12 as much as possible to obtain a sufficient area to provide the insertion structure 151, the terminal ports 152 and so on.

As known from experiments, if the angle formed by the insertion direction I and the maximum projection surface A, the maximum size direction M of the battery cell assembly 12 exceeds 45 degrees, the length that can be obtained by the insertion direction I being reduced as the angle increases. Furthermore, the maximum projection surface B of the battery housing 11 and the maximum projection surface A of the battery cell assembly 12 are generally overlapped to make the battery pack 100 structurally compact. Therefore, when the angle formed by the insertion direction I and the maximum projection surface A of the battery cell assembly 12 exceeds 45 degrees, the housing area of the battery housing 11 that can be used by the insertion structure 151 reduces as the angle increases. Hence, the present disclosure employs the above design solution.

As a preferred solution, the insertion direction I may be parallel to the maximum projection surface A and the maximum size direction M of the battery cell assembly 12.

As a further preferred solution, a maximum projection surface C of the insert housing wall 15 overlaps the maximum projection surface A of the battery cell assembly 12. Furthermore, they both overlap with the maximum projection surface B of the battery housing 11. That is to say, the battery housing 11 and the battery cell assembly 12 have the same maximum projection surfaces B, A, and the maximum projection surface C of the insert housing wall 15 for forming the insertion structure 151 in the battery housing 11 also overlaps with them. Such design is advantageous in that the battery housing 11 can receive the battery cell assembly 12 with a relatively compact space structure, and the insert housing wall 15 has an enough size to form the insertion structure 151.

In the insertion direction I, the insertion structure 151 at least comprises an insertion starting end S and an insertion terminating end E, and the terminal ports 152 are located on a side of the insertion structure 151 adjacent to the insertion terminating end E. Further preferably, the terminal ports 152 may be disposed at the insertion terminating end E. Such arrangement is provided such that the connection terminal 13 cannot be contacted immediately at the beginning of the insertion and can be contacted only after insertion is performed to a certain degree. This ensures that insertion and power supply performed by the user is a real intention but not a misoperation. Correspondingly, upon being detached, the electrical connection is disconnected and thus safe use can be ensured once the detachment is completed.

The insertion structure 151 comprises insertion slots 151a and a receiving slot 151b.

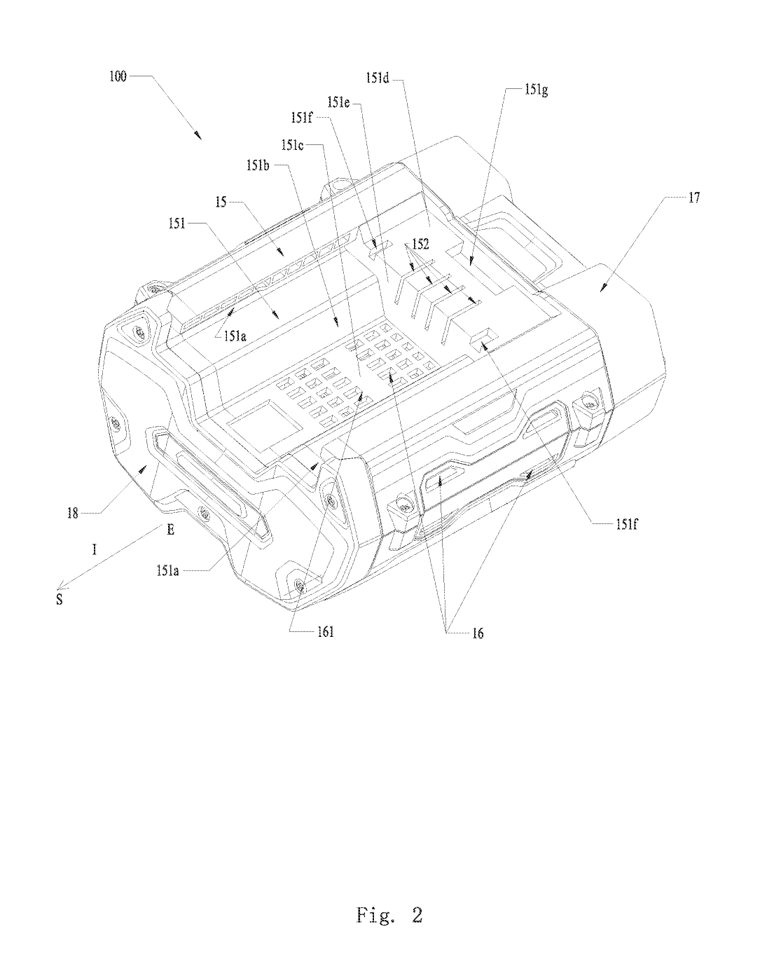

To facilitate introduction of the specific solution of the insertion structure 151, referring to FIG. 2, a direction perpendicular to the maximum projection surface C of the insert housing wall 15 is regarded as an up-down direction, a direction parallel to the insertion direction I is regarded as a front-rear direction, a side where the insertion starting end S is located is regarded as a front side, and a side where the insertion terminating end E is located is regarded as a rear side.

Two insertion slots 151b are respectively disposed on left and right sides above the receiving slot 151a, the insertion slots 151a and the receiving slot 151b are all opened on the front side, the two insertion slots 151a are respectively opened leftwards and rightwards, and the receiving slot 151b is recessed downward and opened upward.

As a preferred solution, the insert housing wall 15 forms a stop wall surface 151e behind the receiving slot 151b, and the terminal ports 152 are partially provided on the stop wall surface 151e and located between the two insertion slots 151a.

The stop wall surface 151e functions to stop relative movement of the charger 200 or the electric tool 300 relative to the battery pack 100 upon completion of the insertion. Therefore, in this embodiment, a location of the stop wall surface 151e may be regarded as the insertion terminal end E, and the end of the insertion slots 151a and the receiving slot 151b on the forwardly open side may be regarded as the insertion starting end S. The terminal ports 152 are partially provided at the location so that a structure cooperating with the connection terminal 13 can be completely inserted in the battery housing 11 to cooperate therewith upon completion of insertion.

It shall be noted that, the relative position of the terminal ports 152 in the insertion direction I and the insertion slots 151a and receiving slot 151b are designed for the following purpose. Since the battery pack 100 according to the present disclosure at least has an output voltage of 56V, it can be dangerous for a human body to directly contact either the connection terminal 13 of the battery pack itself or a corresponding electrical connection structure of the charger 200 and the electric tool 300. Furthermore, as needed by transmission of electrical energy, these structures must have a certain size, for example, for the sake of security, the connection terminal 13 is disposed in the interior of the battery housing 11. Hence, its insertion and a terminal forming connection with it must require a sufficient insertion size, so it must be ensured that when the terminals forming electrical connection are not yet completely disconnected during insertion and detachment, the user cannot contact them. According to the above technical solution of the present disclosure, firstly, security assurance is achieved from a relative position of the terminal port 152 in the insertion direction I. According to the previous solution, upon ether insertion or detachment, when the connection terminal 13 is still electrically connected with an external terminal, the charger 200 or the electric tool 300 is adjacent to the insertion terminating end E in the insertion direction I relative to the battery pack 100. At this position, by virtue of the design of the positions of the inserting structure 151 comprising the insertion slots 151a and the receiving slot 151b as well as the terminal ports 152, it is difficult for the user to extend his finger into the receiving slot 151b to contact terminals whose electrical connection is not yet disconnected.

As a preferred solution, the insert housing wall 151 is formed with a wall surface structure having an L-shaped section. The wall surface structure comprises a locking wall surface 151d corresponding to one of the edges of the L-shape and a stopping wall surface 151e corresponding to the other of the edges of the L-shape. The locking wall surface 151d is parallel to the maximum projection surface C of the insert housing wall 151, and the stopping wall surface 151e is perpendicular to the maximum projection surface C of the insert housing wall 151. One of the terminal ports 151 is formed by hollowing the locking wall surface 151d and the stopping wall surface 151e and a connection location there between.

As a preferred solution, a left-right distance W of a bottom surface of the insertion slot 151a is in a range of 90 mm to 95 mm.

The insertion slot 151a at least comprises two different segments in the front-rear direction, a cross section of a forward segment D1 is greater than that of a rearward segment D2, and a transition segment D3 having a gradually changing cross section may be provided there between. Such arrangement is advantageous in that the larger segment D1 makes the matching at the beginning of the insertion easier, and meanwhile the rearward segment D2 having a thicker slot wall ensures structural strength and tight mating degree as needed for load carrying after completion of the insertion. Preferably, a length L1 of the insertion slot 151a in the insertion direction I is in a range of 90 mm to 100 mm, more specifically 97.3 mm, wherein the forward segment is 44.4 mm, the transition segment D3 is 6.1 mm and the rearward segment is 46.8 mm; a slot width (a dimension in an up-down direction in the slot) W1, W2 of the forward segment D1 and rearward segment D2 of the insertion slot are respectively 10.4 mm and 8.4 mm. Such dimensions can ensure the insert housing wall 15 has a sufficient structural strength when being made of a general engineering plastic.

Four terminal ports 152 are arranged left-right symmetrically, each terminal port 152 is a left-right symmetrical structure, and a distance of the two terminal ports 152 in the middle is smaller than or equal to a distance between one of the terminal ports 152 in the middle and the respective outside terminal port 152. A battery pack positive connection terminal and a battery pack negative connection terminal are correspondingly provided at the two outside terminal ports 152; a communication connection terminal and a temperature connection terminal are correspondingly provided at the two inside terminal ports 152. Such arrangement is advantageous in that a farther distance between the battery pack positive connection terminal and the battery pack negative connection terminal effectively prevents short-circuiting and meanwhile effectively uses the space therebetween.

Two wrong insertion-preventing slots 151f having different sizes are provided at a connection of the locking wall surface 151d and the stopping wall surface 151e and arranged inside the two insertion slots 151a in the left-right direction. The wrong insertion-preventing slots 151f can effectively prevent the terminal port 152 from being wrongly inserted.

As a preferred solution of specific dimensions, the terminal port 152 is configured to have a dimension W3 in the left-right direction in a range of 1.5 mm to 2 mm, a dimension H1 in the up-down direction in a range of 15 mm to 20 mm, and a dimension L2 in the front-rear direction in a range of 10 mm to 20 mm. A centerline of left-right symmetry of the terminal port 152 is called a central line, and a distance between the central lines of adjacent terminal ports 152 is in a range of 3 mm to 12 mm. A distance W4 between the central lines of the two middle terminal ports 152 is preferably 8 mm, and a distance W5 between the central line of the middle terminal port 152 and the central line of the outside terminal port 152 is preferably 10 mm.

As a preferred solution, the battery housing 11 further comprises a heat dissipation structure 16 to discharge the heat generated by the battery cell assembly 12 out of the battery housing 11.

Generally, the heat dissipation structure 16 can be distributed everywhere in the battery housing 11, e.g., through holes, air ducts or the like for heat dissipation purpose.

Specifically, the heat dissipation structure 16 at least comprises a main heat dissipation window 161 disposed at the insert housing wall. Preferably, the main heat dissipation window 161 may be formed by arranging a plurality of identical through holes.

Regarding the battery cell assembly 12, the main heat dissipation window 161 is disposed at a location corresponding to the groove 124b of the battery cell assembly 12, thereby achieving efficient heat dissipation.

As far as the battery housing 11 is concerned, at the receiving slot 151b, the insert housing wall 15 is provided with a main heat dissipation panel 151c parallel to the maximum projection surface C of the insert housing wall 15, the main heat dissipation window 161 is disposed at the main heat dissipation panel 151c of the receiving slot 151b because this location corresponds to the groove 124b at the connecting unit body 124 of the battery cell assembly 12, and this location, relative to the insert housing wall 15, has a sufficient area to provide the main heat dissipation window 161 without affecting the structural strength of the insertion slots 151a on both sides.

As a further preferred solution, a ratio of a heat dissipation area of the main heat dissipation window 161 to a total heat dissipation area of the heat dissipation structure 16 is in a range of 0.4 to 0.6; a ratio of the total heat dissipation area of the heat dissipation structure 16 to a volume of the battery housing 11 is in a range of 0.0005 mm²/mm³ to 0.0012 mm²/mm³; a ratio of the total heat dissipation area of the heat dissipation structure 16 to a surface area of the battery housing 11 is in a range of 0.015 to 0.030.

Such arrangement aims to ensure a sufficient heat dissipation area at the connecting unit body 23 to dissipate heat. When the technical solution shown in FIG. 1 is employed, it is detected that a good heat dissipation effect can be achieved if the ratio of the total heat dissipation area of the heat dissipation structure 16 to a volume of the battery housing 11 and the ratio of the total heat dissipation area of the heat dissipation structure 16 to a surface area of the battery housing 11 are maintained in the above ranges.

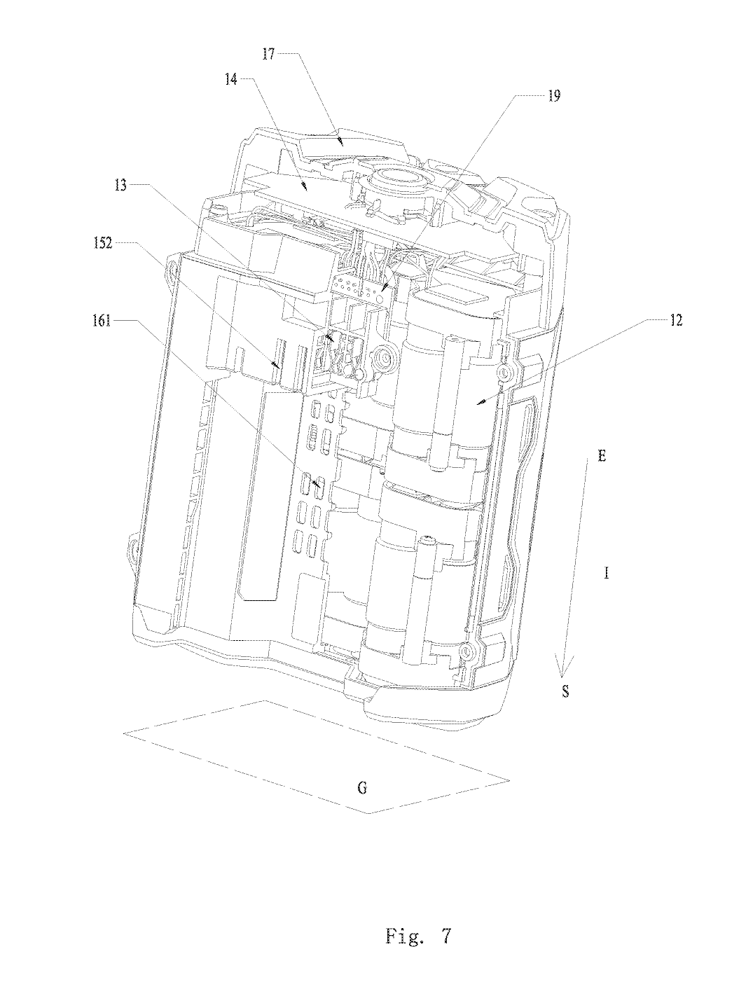

Referring to FIG. 7, the battery pack 100 further comprises a main control circuit board 14 disposed in the battery housing 11, wherein a maximum projection surface G of the main control circuit board 14 is perpendicular to the insertion direction I.

Assume that a direction parallel to the insertion direction I be regarded as a front-rear direction, a side where the insertion starting end S is located is regarded as a front side, and a side where the insertion terminating end E is located is regarded as a rear side; the main control circuit board 14 is located behind the battery cell assembly 12 and spaced apart from it at least 15 mm. The battery housing 11 further comprises an end cap 17 whose maximum projection surface G is perpendicular to the maximum projection surface A of the battery cell assembly 12. The end cap 17 is formed with a receiving space for receiving the main control circuit board 14. Such arrangement is advantageous in avoiding the heat generated by the main control circuit board 14 from exerting a larger influence on the battery cell assembly 12, meanwhile individually encapsulating the main control circuit board 14 in the end cap 17, reducing its blocking to heat dissipation of the battery cell assembly 12, and facilitating performance of wiring and encapsulation in the embodiment as shown in FIG. 7. As a further preferred solution, the battery pack 100 further comprises an auxiliary circuit board 19 smaller than the main control circuit board 14. The auxiliary circuit board 19 is disposed in a direction perpendicular to the main control circuit board 14 and arranged between the battery cell assembly 12 and the connection terminal 13. The auxiliary circuit board 19 forms electrical connection with the connection terminal 13.

As a preferred solution, a distance of the connection terminal 13 from an outer surface of the insert housing wall 15 is greater than or equal to 7 mm; more specifically, a distance of the connection terminal 13 from an outer surface of the insert housing wall 15 at the terminal port 152 is greater than or equal to 7 mm. That is to say, in a scope of the terminal port 152, an object that cannot pass through the terminal port 152 is at least 7 mm away from the connection terminal 13. Such arrangement is advantageous in avoiding a hidden danger caused by a too short distance between a finger and the connection terminal 13. It is found from experiments that a voltage of 56V is by far insufficient to cause breakdown in air and discharge at a distance of 5 mm.

As a preferred solution, in the insertion direction I of the insertion structure 151, a center of gravity of the battery pack 100 is located between the insertion starting end S and the insertion terminating end E. Such arrangement is advantageous in that the user can conveniently master the battery pack 100 upon insertion to complete the insertion or detachment action.

As a preferred solution, an electrical energy capacity of the battery pack 100 is greater than 100 Wh; a ratio of the electrical energy capacity of the battery pack 100 to its weight is greater than 70 Wh/kg and less than 100 Wh/kg; a ratio of the electrical energy capacity of the battery pack 100 to its volume is greater than 70 Wh/cm³ and less than 100 Wh/cm³. Such arrangement is advantageous as follows: the output voltage of at least 56V of the battery pack 100 of the present disclosure indicates that it is designed for some electric tools with larger power. According to detection of some commonly-used electric tools with larger power, if the electrical energy capacity thereof is smaller than 100 Wh, it cannot meet the needs of continued operation of these larger-power electrical tools. These larger-power electric tools comprise mowers, grass trimmers, chain saws, pruners, air blowers and the like. If a ratio of the electrical energy capacity of the battery pack 100 to its weight is too large, much additional weight will occurs in the battery pack 100 so that the user must operate with extra force; if the ratio is too small, the battery cell assembly 12 is not sufficient to provide the output voltage of 56V and continued operation capability. The purpose of determining the ratio of the electric energy capacity of the battery pack 100 to its volume lies in that the heat generation of the battery cell assembly 12 is usually related to the electric energy capacity, setting the ration in the above range can enable the battery pack 100 with an output voltage of 56V to perform effective heat dissipation and keep the battery pack 100 from overheat.

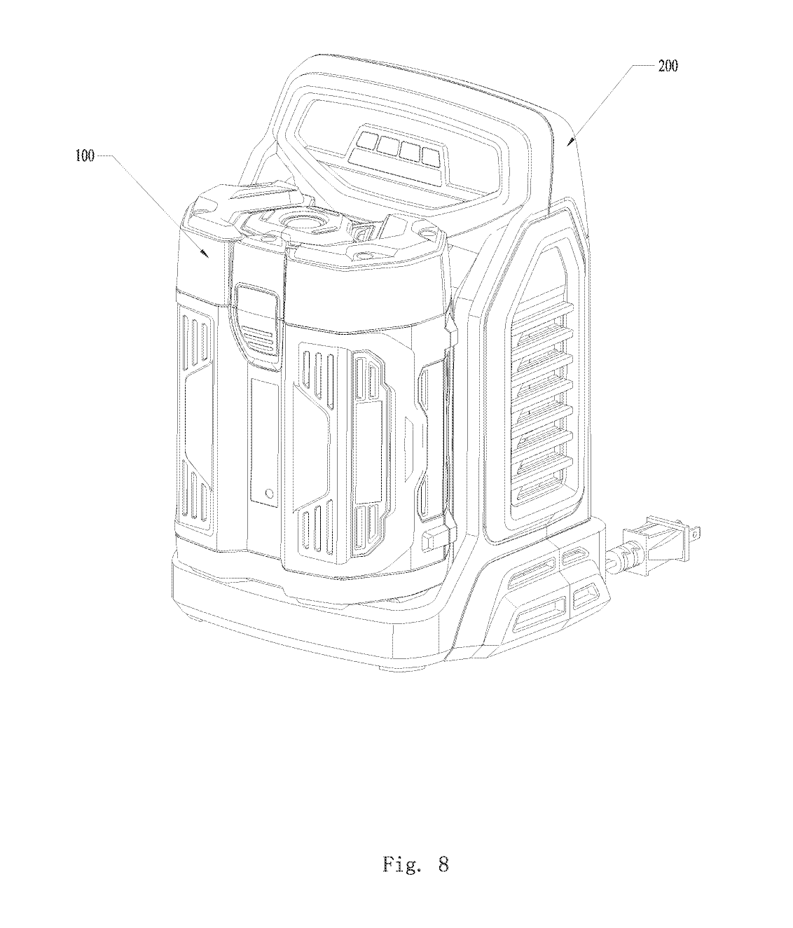

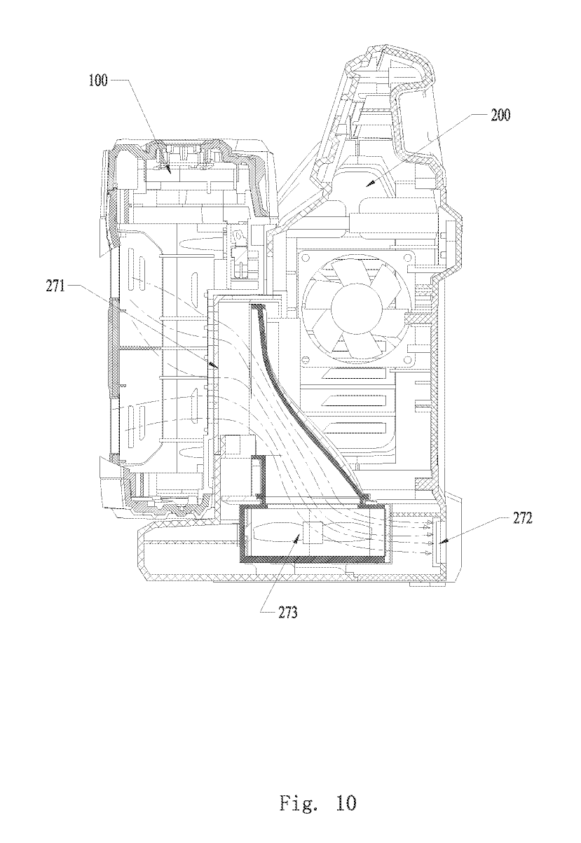

Referring to FIG. 8 to FIG. 13, the charger 200 of the present disclosure comprises a charging housing 21, a charging device, and charging terminals 23 electrically connecting the charging device 22 to the battery pack 100. The charging housing 21 comprises a charging housing wall 26 including a mounting structure 261 for mounting the battery pack 100 to a mounting position, the mounting structure 261 at least has a mounting direction K which forms an angle greater than or equal to 0 degree and less than or equal to 45 degrees with respect to the maximum projection surface F of the charging housing wall 26.

As a preferred solution, the mounting direction K is parallel to a maximum projection surface F of the charging housing wall 26. The mounting structure 261 comprises insertion protrusions 261a and a positioning protrusion 261b, and the mounting structure 261 at least comprises in the mounting direction K a mounting starting end S′ and a mounting terminating end E′. A direction perpendicular to the maximum projection surface F of the charging housing wall 26 is regarded as an up-down direction, and the charging housing wall 26 is located on an upper side in the charging housing 21. Assume that the direction parallel to the mounting direction K is the front-rear direction, a side where the mounting starting end S′ is located is regarded as a front side, and a side where the mounting terminating end E′ is located is regarded as a rear side. The positioning protrusion 261b is protruded upwardly, and two insertion protrusions 261a are respectively disposed on left and right sides of the positioning protrusion 261b and respectively protruded leftwards and rightwards. At a front end of the insertion protrusion 261a and the positioning protrusion 261b, the charging housing wall 26 is formed with a positioning wall surface 261c for stopping the battery pack 100 to limit it in the mounting position. The charging terminal 23 is located on a side of the mounting structure 26 adjacent to the mounting starting end S′.

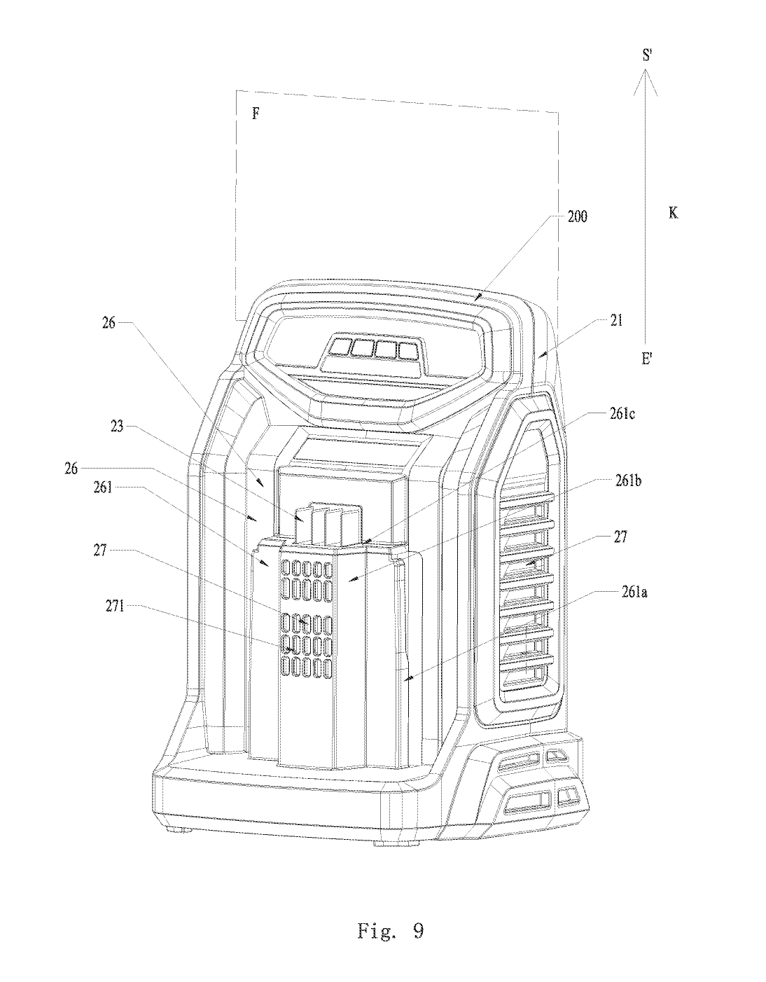

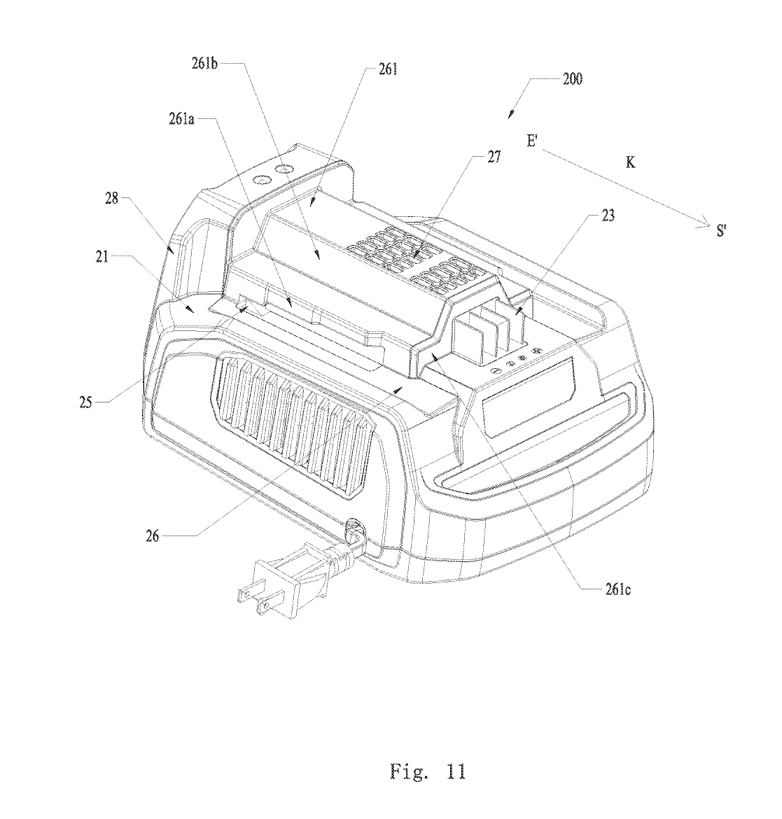

The charger 200 of the present disclosure may be in two forms as shown in FIG. 9 and FIG. 11. One is an upstanding type, and the other is a horizontal type, wherein the mounting direction K of the upstanding type is parallel to a vertical direction, and the mounting direction K of the horizontal type is parallel to the horizontal direction. Preferably, in the horizontal type, the charger 200 is provided two protrusions 28 to be caught by the user, the protrusions 28 are protruded in a horizontal direction and perpendicular to the mounting direction K, and thus symmetrically provided on one side of the positioning protrusion 261b adjacent to the mounting terminating end E′.

As can be seen from the above, the mounting structure 261 of the charging housing wall 26 in the charger 200 of the present disclosure is adapted for the insertion structure 151 of the battery pack 100 of the present disclosure, the insertion slot 151a corresponds to the insertion protrusion 261a, the receiving slot 151b corresponds to the positioning protrusion 261b, so the specific dimensions of the mounting structure may be designed by referring to the corresponding dimensions of the insertion structure 151.

As a preferred solution, to make the charging terminal 23 of the charger 200 not be in a charging state when the battery pack 100 is not yet inserted and thereby ensure the security of the user, the charger 200 further comprises a safety switch 2 disposed in the charging housing 21 and configured to control whether the charging terminal 23 is charged or not. Furthermore, an insurance switch 25 is provided at the mounting terminating end E′ to be triggered by contact of the battery pack 100 at the mounting position and reset when the battery pack 100 retreats out of the mounting position. The insurance switch 25 forms a linkage with the safety switch 24. When the insurance switch 25 is triggered, the safety switch 24 places the charging terminal 23 into the charging state; when the insurance switch 25 is reset, the safety switch 24 places the charging terminal 23 into the uncharged state.

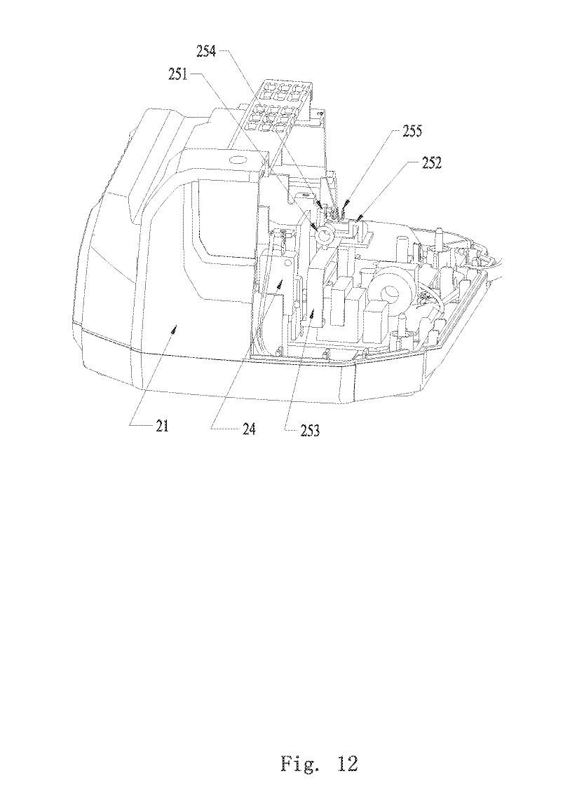

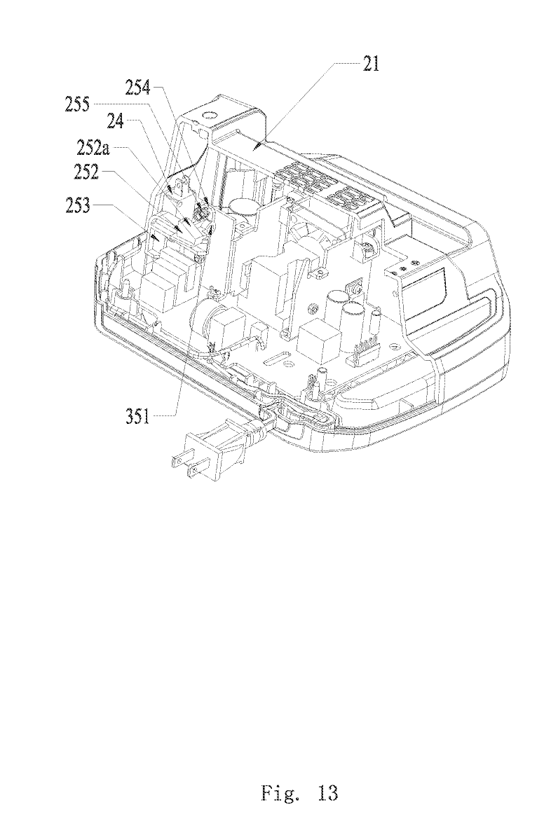

It specifically may employ the solution as shown in FIGS. 12 and 13. The insurance switch 25 comprises four portions: a rotation shaft portion 251 allowing for rotatable connection with the charging housing 21, a contact portion 252 exposed at the mounting terminating end E′ of the insertion protrusion 261a, a trigger portion 253 for triggering a contact of the safety switch 24, and resetting portion 254 fixed with an elastic member 255 and allowing it to be reset. The rotation shaft portion 251 enables the insurance switch 25 and the charging housing 21 to form a rotatable connection with the rotation shaft parallel to the mounting direction K, an exposed portion of the contact portion 252 forms an inclined surface 252a so that when the battery pack 100 gradually contacts with it in the mounting direction K, and when the insurance switch 25 rotates to a certain degree (i.e., when the battery pack 100 is inserted to the bottom), the trigger portion 253 triggers the contact of the safety switch 24 to place the charging terminal 23 into the charging state; when the battery pack 100 is detached, the contact portion 252 is not pressed again, whereupon the fixed elastic member 255 on the resetting portion 254 enables the insurance switch 25 to restore to an initial state, the contact of the safety switch 24 is released, and the charging terminal 23 is not charged.

As a preferred solution, to allow the battery pack 100 and the charger 200 to obtain a good heat dissipation effect upon charging, the charging housing 21 is formed with an air duct structure 27, the air duct structure 27 at least comprises an air inlet 271 and an air outlet 272. The air inlet 271 is disposed at the charging housing wall 26, and the charger is provided with an air flow element 273 in a channel between the air inlet 271 and the air outlet 272. Preferably, the air flow element 273 may be a fan. A ratio of the air inlet 271 to the air outlet 272 is greater than or equal to 1 and less than or equal to 2. It is better that the air inlet 271 is greater than 1500 mm², and an area of the air outlet 272 is greater than 1000 mm². When the battery pack 100 and the charger 200 are performing charging, the air inlet 271 is disposed exactly corresponding to the main heat dissipation window 161 of the battery pack 100 so that a complete air duct is formed in the battery pack 100 and the charger 200.

As a preferred solution, the charger 200 at least has a charging voltage of 56V and a charging power of 550 W. The charging terminal 23 is configured as a sheet-shaped terminal with a thickness in a range of 0.5 mm to 1 mm and a distance extending out of the housing of the tool in the front direction and the up-down direction i in a range of 15 mm to 20 mm. The charging terminal 23 extends out of the charging housing 21 at least 7 mm.

A charging assembly of the present disclosure comprises the battery pack 100 and the charger 200 described above.

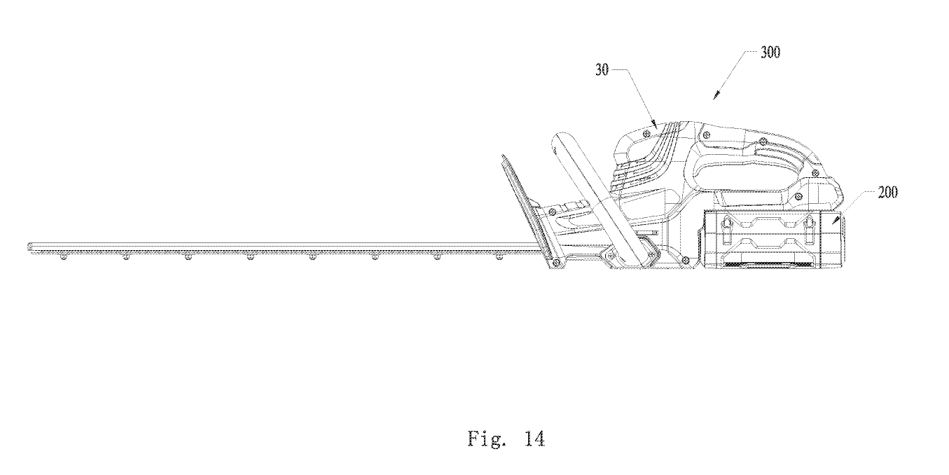

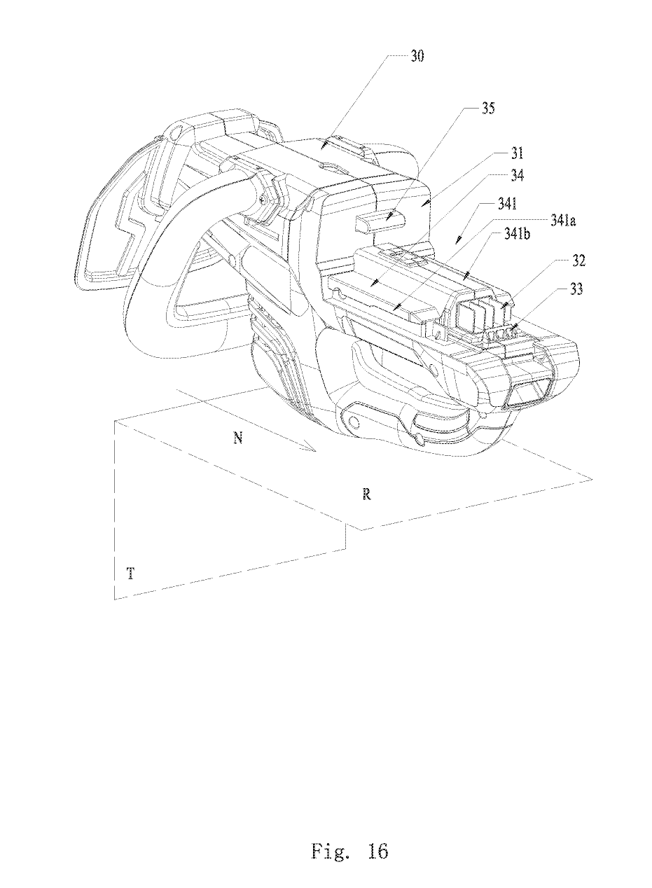

Referring to FIGS. 14 to 16, the electric tool 300 according to the present disclosure comprises a main machine 30 and the above-mentioned battery pack 100.

The main machine 30 comprises a motor, a tool housing 31, and a tool terminal 32 for forming electrical energy or signal transmission with the battery pack 100, wherein the motor is disposed in the tool housing 31. The tool housing 31 comprises a loading housing wall 34 comprising a loading structure 341 for loading the battery pack 100 to a loading position (namely, a position as shown in FIG. 14).

The loading structure 341 at least has a loading direction N parallel to the insertion direction I. The loading structure 341 comprises loading protrusions 341a and a central protrusion 341b, a direction perpendicular to a maximum projection surface R of the tool housing wall 31 is regarded as an up-down direction, and a direction parallel to a loading direction N is regarded as a front-rear direction. The central protrusion 341b is protruded upward, and two loading protrusions 341a are respectively provided on left and right sides of the lower portion of the central protrusion 341b and respectively protruded leftwards and rightwards. Generally, to be mounted with the battery pack 100, the loading housing wall 34 of the main machine 30 has substantially the same structure as the charging housing wall 26 of the charger 200, so the structure and relevant dimensions of the loading housing wall 34 may be designed with reference to the corresponding structures of the charging housing wall 26.

As a preferred solution, the main machine 30 comprises a locking mechanism 33 for locking the battery pack 100 at a loading position, and the insert housing wall 26 is formed with a locking structure 151g cooperating with the locking mechanism 33. Preferably, the locking structure 151g may be disposed at a locking wall surface 151d.

The main machine 30 further comprises an ejection structure 35 for ejecting the battery pack 100 out of the loading position, and the battery pack 100 is provided with an ejection wall surface 18 contacting with the ejection mechanism 35. A maximum projection surface T of the ejection wall surface 18 is perpendicular to the loading direction N.

Preferably, a distance of the tool terminal 32 from an outer surface of the loading housing wall 34 is greater than or equal to 7 mm. The tool terminal 32 is configured as a sheet-shaped terminal with a thickness in a range of 0.5 mm to 1 mm and a distance extending out of the tool housing 31 in a range of 15 mm to 20 mm.

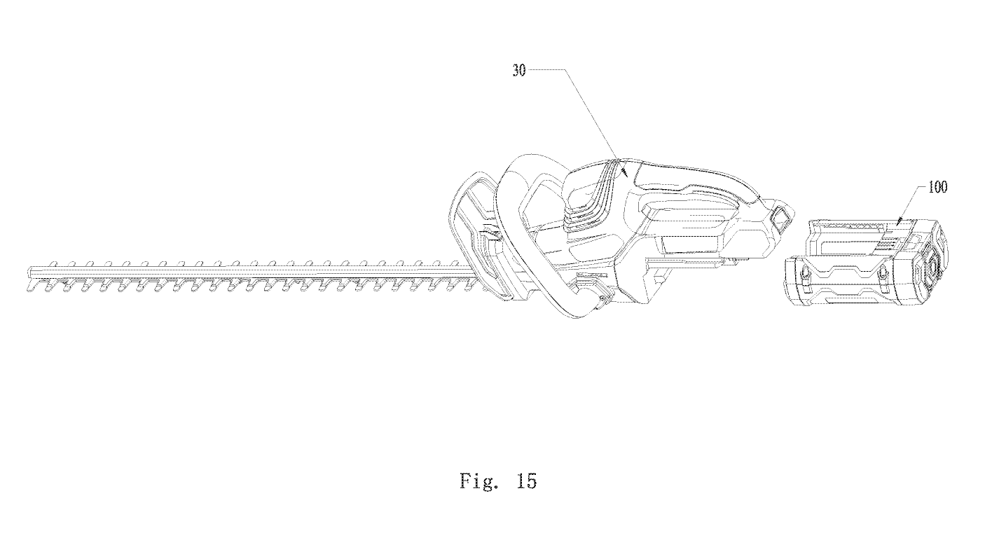

As a preferred solution, the electric tool 300 is a pruner as shown in FIG. 15. In this case, a weight ratio of the battery pack 100 and the main machine 30 is in a range of 0.4 to 0.6.

Certainly, the electric tool may be a mower, chain saw, grass trimmer, pruner, or air blower.

When the electric tool of the present disclosure is a mower, a weight ratio of the battery pack 100 and the main machine 30 is in a range of 0.04 to 0.14.

When the electric tool of the present disclosure is a chain saw, a weight ratio of the battery pack 100 and the main machine 30 is in a range of 0.250 to 0.875.

When the electric tool of the present disclosure is a grass trimmer, a weight ratio of the battery pack 100 and the main machine 30 is in a range of 0.3 to 0.8.

When the electric tool of the present disclosure is an air blower, a ratio weight of the battery pack 100 and the main machine 30 is in a range of 0.04 to 1.

Besides, as a preferred solution, the battery pack 100 of the present disclosure may use a phase change material to encapsulate the battery cell units 121 to maintain a rise rate of a temperature of the battery pack 100 below 0.9 degrees/minute.

The above illustrates and describes basic principles, main features and advantages of the present disclosure. Those skilled in the art should appreciate that the above embodiments do not limit the present disclosure in any form. Technical solutions obtained in a way of equivalent substitution or equivalent variations all fall within the scope of the present disclosure.

What is claimed is:

1. A battery pack, comprising:
a battery housing;
a battery cell assembly within the battery housing; and
at least two connection terminals associated with the battery housing and capable of transmitting electrical energy or signals;
wherein the battery housing comprises an insert housing wall, the battery cell assembly comprises more than one battery cell unit, the battery pack has at least has an output voltage of 56V, the insert housing wall comprises an insertion structure and terminal ports for the at least two connection terminals, and the insertion structure at least has an insertion direction which forms an angle greater than or equal to 0 degree and less than or equal to 45 degrees with respect to a maximum projection surface or a maximum size direction of the battery cell assembly.

2. The battery pack according to claim 1, wherein the insertion structure at least comprises an insertion starting end and an insertion terminating end in the insertion direction, and the terminal ports are located on a side of the insertion structure adjacent to the insertion terminating end.

3. The battery pack according to claim 2, wherein the maximum projection surface of the insert housing wall overlaps the maximum projection surface of the battery cell assembly and the insertion direction is parallel to the maximum projection surface and the maximum size direction of the battery cell assembly, the insertion structure comprises insertion slots and a receiving slot, a direction perpendicular to the maximum projection surface of the insert housing wall is regarded as an up-down direction, a direction parallel to the insertion direction is regarded as a front-rear direction, a side where the insertion starting end is located is regarded as a front side, and a side where the insertion terminating end is located is regarded as a rear side, two insertion slots are respectively disposed on left and right sides above the receiving slot, the insertion slots and the receiving slot are opened on the front side, the two insertion slots are respectively opened leftwards and rightwards, the receiving slot is recessed downwards and opened upwards, and a distance of the connection terminal from an outer surface of the insert housing wall is greater than or equal to 7 mm.

4. The battery pack according to claim 3, wherein the insert housing wall forms a stop wall surface behind the receiving slot, the terminal ports are partially arranged on the stop wall surface and located between the two insertion slots, the insert housing wall is formed with a wall surface structure having an L-shaped section, the wall surface structure comprises a locking wall surface corresponding to one edge of the L-shape and the stopping wall surface corresponding to the other edge of the L-shape, the locking wall surface is parallel to the maximum projection surface of the insert housing wall, the stopping wall surface is perpendicular to the maximum projection surface of the insert housing wall, and one of the terminal ports is formed by hollowing the locking wall surface and the stopping wall surface as well as a connection portion there between.

5. The battery pack according to claim 2, wherein four terminal ports are symmetrically arranged left-right, each terminal port has a left-right symmetrical structure, a distance between two terminal ports in the middle is smaller than or equal to a distance between one of the two terminal ports in the middle and the respective outside terminal port, a battery pack positive connection terminal and a battery pack negative connection terminal are correspondingly provided at the two outside terminal ports, and a communication connection terminal and a temperature connection terminal are correspondingly provided at the two inside terminal ports.

6. The battery pack according to claim 1, wherein in the insertion direction of the insertion structure, a center of gravity of the battery pack is located between the insertion starting end and the insertion terminating end.

7. The battery pack according to claim 1, wherein a ratio of the electrical energy capacity of the battery pack to its weight is greater than 70 Wh/kg and less than 100 Wh/kg; and a ratio of the electrical energy capacity of the battery pack to its volume is greater than 70 Wh/cm³ and less than 100 Wh/cm³.

8. A charger for a battery pack, comprising:
a charging housing;
a charging device carried by the charging housing; and
a charging terminal for electrically connecting the charging device to the battery pack;
wherein the charging housing comprises a charging housing wall including a mounting structure for mounting the battery pack in a mounting position, the mounting structure at least having a mounting direction which forms an angle greater than or equal to 0 degree and less than or equal to 45 degrees with respect to a maximum projection surface of the charging housing wall.

9. The charger according to claim 8, wherein the charger further comprises a safety switch disposed in the charging housing and configured to control whether the charging terminal is to be charged or not.

10. The charger according to claim 9, wherein the mounting direction is parallel to the maximum projection surface of the charging housing wall, the mounting structure comprises insertion protrusions and a positioning protrusion, the mounting structure comprises a mounting starting end and a mounting terminating end in the mounting direction, a direction perpendicular to the maximum projection surface of the charging housing wall is regarded as an up-down direction, the charging housing wall is located on an upper side in the charging housing, a direction parallel to the mounting direction is regarded as a front-rear direction, a side where the mounting starting end is located is regarded as a front side, a side where the mounting terminating end is located is regarded as a rear side, the positioning protrusion is protruded upwardly, and two insertion protrusions are respectively disposed on left and right bottom sides of the positioning protrusion and respectively protruded leftwards and rightwards.

11. The charger according to claim 10, wherein at a front end of the insertion protrusion and the positioning protrusion, a positioning wall surface is formed on the charging housing wall for stopping the battery pack to limit insertion to the mounting position and the charging terminal is located on a side of the mounting structure adjacent to the mounting starting end.

12. The charger according to claim 11, wherein an insurance switch is provided at the mounting terminating end to be triggered by contact of the battery pack at the mounting position and to be reset when the battery pack retreats out of the mounting position, the insurance switch forming a linkage with the safety switch, the safety switch causing the charging terminal to be charged when the insurance switch is triggered, and the safety switch causing the charging terminal to be uncharged when the insurance switch is reset.

13. The charger according to claim 12, wherein the charging housing is formed with an air duct structure, the air duct structure comprises an air inlet and an air outlet, the air inlet is disposed at the charging housing wall, and the charger is provided with an air flow element in a channel between the air inlet and the air outlet.

14. The charger according to claim 13, wherein the charging terminal is disposed at the positioning wall surface and located between the two insertion protrusions and the maximum projection surface of the charging housing wall is perpendicular to a horizontal plane.

15. The charger according to claim 14, wherein the charger at least has a charging voltage of 56V and a charging power of 550 W, the charging terminal is configured as a sheet-shaped terminal with a thickness in a range of 0.5 mm to 1 mm, and a distance extending out of the charging housing in the front direction and the up-down direction is in a range of 15 mm to 20 mm.

16. An electric tool, comprising:
a main machine; and
a battery pack for providing power to the main machine, the battery pack comprising a battery housing, a battery cell assembly carried by the battery housing, and at least two connection terminals for transmitting electrical energy or signals, wherein the battery housing comprises an insert housing wall, the battery cell assembly comprises more than one battery cell unit, the battery pack at least has an output voltage of 56V, the insert housing wall comprises an insertion structure and terminal ports in which are disposed the at least two connection terminals, and the insertion structure at least having an insertion direction which forms an angle greater than or equal to 0 degree and less than or equal to 45 degrees with respect to a maximum projection surface or a maximum size direction of the battery cell assembly;
wherein the main machine comprising a motor, a tool housing, and a tool terminal for forming electrical energy or signal transmission connection with the battery pack, the motor being disposed in the tool housing, and the tool housing comprises a loading housing wall having a loading structure for loading the battery pack to a loading position.

17. The electric tool according to claim 16, wherein the loading structure at least has a loading direction parallel to the insertion direction, the loading structure comprises loading protrusions and a central protrusion, a direction perpendicular to the maximum projection surface of the tool housing wall is regarded as an up-down direction, a direction parallel to a loading direction is regarded as a front-rear direction, the central protrusion are protruded upward, and two loading protrusions are respectively provided on left and right bottom sides of the central protrusion and respectively protruded leftwards and rightwards.

18. The electric tool according to claim 17, wherein the main machine further comprises a locking mechanism for locking the battery pack at the loading position, the insert housing wall is formed with a locking structure for cooperating with the locking mechanism of the main machine, and an ejection structure for ejecting the battery pack out of the loading position, and wherein the battery pack is provided with an ejection wall surface for contacting the ejection structure and a maximum projection surface of the ejection wall surface is perpendicular to the loading direction.

19. The electric tool according to claim 18, wherein a distance of the tool terminal from an outer surface of the loading housing wall is greater than or equal to 7 mm, the tool terminal is configured as a sheet-shaped terminal with a thickness in a range of 0.5 mm to 1 mm, and a distance extending out of the tool housing in a range of 15 mm to 20 mm.

20. The electric tool according to claim 19, wherein a weight ratio of the battery pack to the main machine is in a range of 0.04 to 0.14 when the electric tool is a mower, a weight ratio of the battery pack to the main machine is in a range of 0.4 to 0.6 when the electric tool is a pruner; a weight ratio of the battery pack to the main machine is in a range of 0.250 to 0.875 when the electric tool is a chain saw, a weight ratio of the battery pack to the main machine is in a range of 0.04 to 1 when the electric tool is an air blower, and a weight ratio of the battery pack to the main machine is in a range of 0.3 to 0.8 when the electric tool is a grass trimmer.
